(19) United States
(12) Patent Application Publication
(10) Pub. No.: US 2026/0119780 A1
(43) Pub. Date: Apr. 30, 2026

(54) CONTROL METHOD AND NON-TRANSITORY COMPUTER READABLE STORAGE MEDIUM

(71) Applicant: BROTHER KOGYO KABUSHIKI KAISHA, Nagoya (JP)

(72) Inventor: Ryo Koyashiki, Nagoya (JP)

(21) Appl. No.: 19/275,979

(22) Filed: Jul. 22, 2025

(30) Foreign Application Priority Data
Oct. 28, 2024 (JP) 2024-188957

(51) Int. Cl. G06F 40/109; B41J 3/407; G06F 40/106

(52) U.S. Cl. CPC G06F 40/109; B41J 3/4075; G06F 40/106

(57) ABSTRACT

A non-transitory computer readable storage medium storing a program executable by an information processing apparatus connected to a label printer and having a label editing function, the program causing the apparatus to execute a display process of displaying, on a user interface of the apparatus, an editing screen that receives editing of a label and on which a font selection object for receiving selection of a font is disposed. The program further causes the apparatus to receive a switching operation of switching an option selectable on the font selection object between a first group of options and a second group of options. The first group of options includes only a printer-compatible font that is a font that the label printer has. The second group of options includes the printer-compatible font and a printer-incompatible font that is a font that the label printer does not have.

### REFERENCE TO RELATED APPLICATIONS

This application claims priority from Japanese Patent Applications No. 2024-188957 filed on Oct. 28, 2024. The entire contents of the priority application are incorporated herein by reference.

### BACKGROUND ART

In a related art, in an information processing apparatus, a configuration in which editing of a label layout is received and a label printer is caused to print the edited label is known. For example, a configuration is known in which, in a document processing apparatus connected to a printer, printer font information provided in the printer is read, usable main body font information registered in a document processing apparatus main body is classified into a printer font group or a non-printer font group based on the read printer font information, and the main body font information is identifiably displayed on the document processing apparatus main body.

When printing is performed by the label printer, it may be preferable to designate a font that the label printer has. In the configuration disclosed in the above related art, the font that the label printer has and a font that the information processing apparatus has are displayed in an identifiable manner, but even with this configuration, there is a possibility that a user selects a font that the label printer does not have, and there is room for improvement.

### SUMMARY

A non-transitory computer readable storage medium storing a program for solving the above-described problems is a program executable by one or more processors of an information processing apparatus connected to a label printer and having a label editing function, the program causing the information processing apparatus to execute: a display process of displaying, on a user interface of the information processing apparatus, an editing screen that receives editing of a label and on which a font selection object for receiving selection of a font is disposed, in which the program further causes the information processing apparatus to receive a switching operation of switching an option selectable on the font selection object between a first group of options and a second group of options, the first group of options includes only a printer-compatible font that is a font that the label printer has, the second group of options includes the printer-compatible font and a printer-incompatible font that is a font that the label printer does not have.

### BRIEF DESCRIPTION OF DRAWINGS

FIG. 1 is a diagram illustrating a schematic configuration of a personal computer including a label creation application.

FIG. 2 is a flowchart illustrating an example of a control procedure of a label editing process.

FIG. 3 is a flowchart illustrating an example of a control procedure of a toggle display control process.

FIG. 4A is a diagram illustrating an example of an editing screen.

FIG. 4B is a diagram illustrating an example of the editing screen.

FIG. 4C is a diagram illustrating an example of the editing screen.

FIG. 5 is a flowchart illustrating an example of a control procedure of an editing process.

FIG. 6A is a diagram illustrating an example of the editing screen.

FIG. 6B is a diagram illustrating an example of the editing screen.

FIG. 6C is a diagram illustrating an example of the editing screen.

FIG. 6D is a diagram illustrating an example of the editing screen.

FIG. 7 is a flowchart illustrating an example of a control procedure of a printing process.

FIG. 8 is a flowchart illustrating an example of a control procedure of a transfer printing process.

FIG. 9 is a diagram illustrating an example of a font incompatible notification.

### DESCRIPTION

Hereinafter, an apparatus according to the present embodiment will be described in detail with reference to the accompanying drawings. The present embodiment discloses a program for causing an information processing apparatus connected to a label printer to edit a label.

### Schematic Configuration of PC

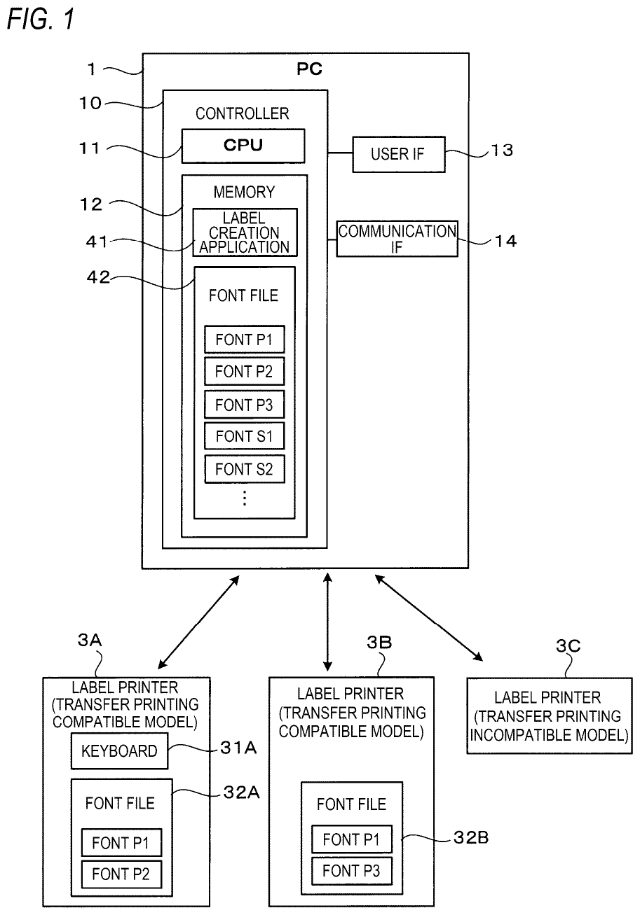

A PC 1 includes a controller 10 including a CPU 11 and a memory 12 as illustrated in FIG. 1. The PC 1 includes a user interface (hereinafter, referred to as a “user IF”) 13, and a communication interface (hereinafter, referred to as a “communication IF”) 14 that are electrically connected to the controller 10. The PC 1 can be communicably connected to label printers 3A, 3B, and 3C. In the following description, when there is no need to specifically distinguish between label printers 3A, 3B, 3C and the components thereof, subscripts may be omitted as appropriate, such as a “label printer 3”. The PC 1 is an example of the “information processing apparatus”. The PC 1 may be a smartphone or a tablet terminal. The label printers connectable to the PC 1 are not limited to the label printers 3A, 3B, and 3C.

The CPU 11 executes various processes according to a program read from the memory 12 and based on a user's operation. The controller 10 in FIG. 1 is a collective term for hardware and software used to control the PC 1, and does not necessarily represent a single piece of hardware actually present in the PC 1.

Various programs including a label creation application program (hereinafter, referred to as a “label creation application”) 41 and various types of data are stored in the memory 12 of the PC 1 of the present embodiment. The memory 12 is used as a work region in a case where various processes are executed.

The CPU 11 may read the label creation application 41 from a storage medium readable by the CPU 11. Examples of the storage medium readable by the CPU 11 include a CD-ROM, a DVD-ROM, and a USB memory.

The label creation application 41 is, for example, a program that receives a user instruction via the user IF 13, edits an image to be printed based on the received instruction, and transmits a print instruction to the label printer 3.

The label creation application 41 includes a font file 42 that stores font information of fonts usable for text data. The font file 42 includes printer-compatible fonts that are fonts that the label printer 3 has and printer-incompatible fonts that the label printer 3 does not have. “Font PO” such as font P1 in FIG. 1 indicates a printer-compatible font, and “font SO” such as font S1 indicates a printer-incompatible font. The font file 42 may include all or some of the printer-compatible fonts provided in the label printer 3 connected to the PC 1.

The label creation application 41 can display a group of options of font options via the user IF 13 and receive a font selection. The label creation application 41 can receive a switching operation of switching between a group of options including only the printer-compatible fonts and a group of options including the printer-compatible fonts and the printer-incompatible fonts.

The label creation application 41 can render the edited label data to generate print data, output the print data to the label printer 3 to be controlled, and cause the label printer 3 as an output destination to perform printing based on the print data. Further, the label creation application 41 of the present embodiment has a transfer printing function of outputting, to the label printer 3 to be controlled, layout data that indicates a layout of the edited label data and is not rendered, causing the label printer 3 at the output destination to render the layout data, and causing printing to be performed based on an image generated by rendering in the label printer 3. The label editing process, the switching process of switching the group of font options, a printing process, and a transfer printing process will be described later. The label creation application 41 is an example of a “program”. The transfer printing function is an example of a “specific printing function”.

The user IF 13 includes hardware that displays a screen for notifying a user of information, and hardware that receives an operation by the user. In the user IF 13, an operation function and a display function may be implemented by separate hardware such as a keyboard and a display, or the operation function and the display function may be implemented by one hardware such as a touch panel.

The communication IF 14 includes hardware for communicating with an external device. Communication standards of the communication IF 14 include Ethernet (registered trademark), Wi-Fi (registered trademark), USB, and the like. The PC 1 may include a plurality of communication IFs 14 corresponding to the plurality of communication standards. The communication method may be wired or wireless.

### Configuration of Label Printer

The label printer 3 is a device that prints an image on a long print medium serving as a label. The label printer 3 has different features and configurations depending on the model. For example, the label printers 3A and 3B are models that include font files 32A and 32B storing fonts, respectively, and can render layout data in which the fonts provided in the font files 32A and 32B are designated. That is, the label printers 3A and 3B are models compatible with the transfer printing function of the label creation application 41. On the other hand, the label printer 3C is a model that does not include a font file and cannot render layout data. That is, the label printer 3C is a model incompatible with the transfer printing function of the label creation application 41. The model of the label printers 3A and 3B is an example of a “specific model”.

The label printer 3A is a model that has a keyboard 31A for receiving an input of information and allows text editing by a main body operation. The label printer 3B is a model that does not have a keyboard and does not allow text editing by a main body operation. The label printer 3A is an example of a “first specific model”, and the label printer 3B is an example of a “second specific model”

### Label Editing Process

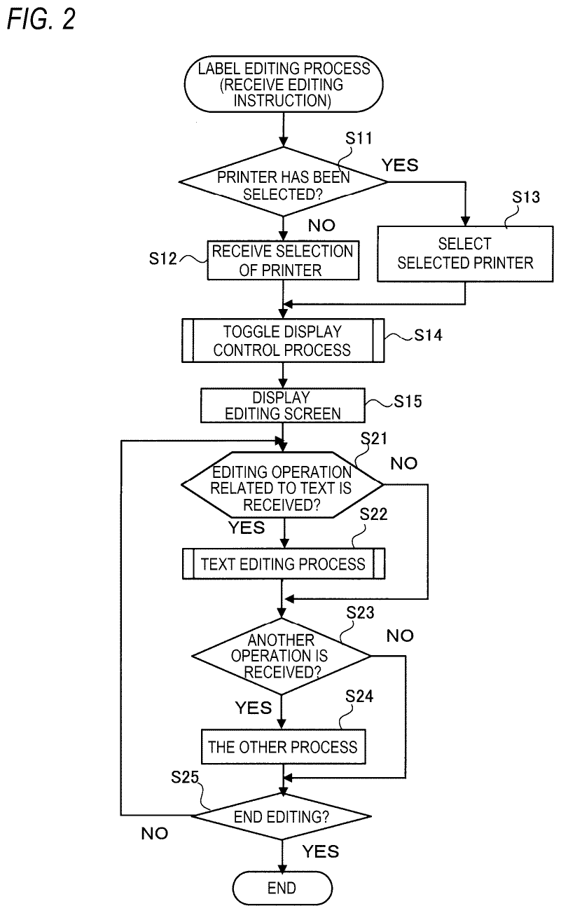

The above-described label editing process will be described. When the label creation application 41 is activated and the PC 1 receives an editing instruction, the CPU 11 executes a label editing process illustrated in FIG. 2 using the label creation application 41. In the label editing process, editing of the label is received via an editing screen 50.

Specifically, the CPU 11 first determines whether the label printer 3 to be controlled has been selected (S11). For example, when the label printer 3 to be controlled is registered in the label creation application 41, the CPU 11 determines that the label printer 3 has been selected (S11: YES). In this case, the CPU 11 selects the selected label printer 3 (S13), and the process proceeds to S14. On the other hand, when the label printer 3 has not been selected (S11: NO), the CPU 11 receives the selection of the label printer 3 (S12), and the process proceeds to S14.

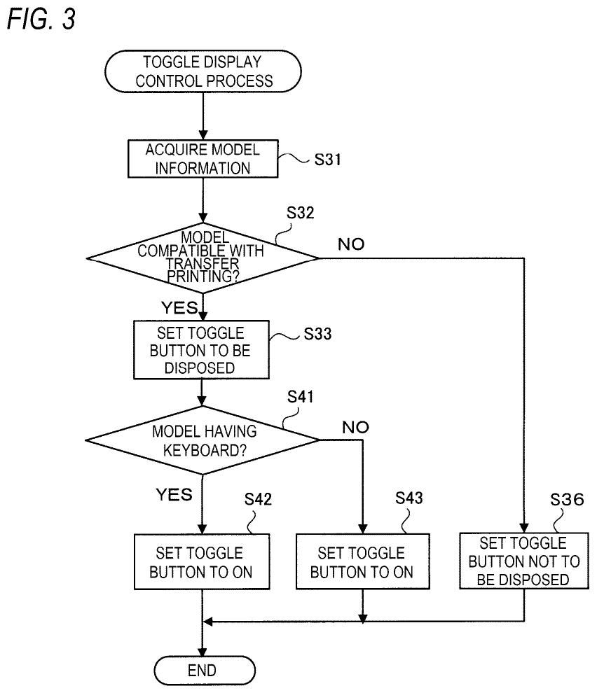

Upon receiving the selection of the label printer 3 to be controlled, the CPU 11 executes a toggle display control process illustrated in FIG. 3 (S14). The toggle display control process is a process of controlling display of a toggle button on an editing screen for editing a label.

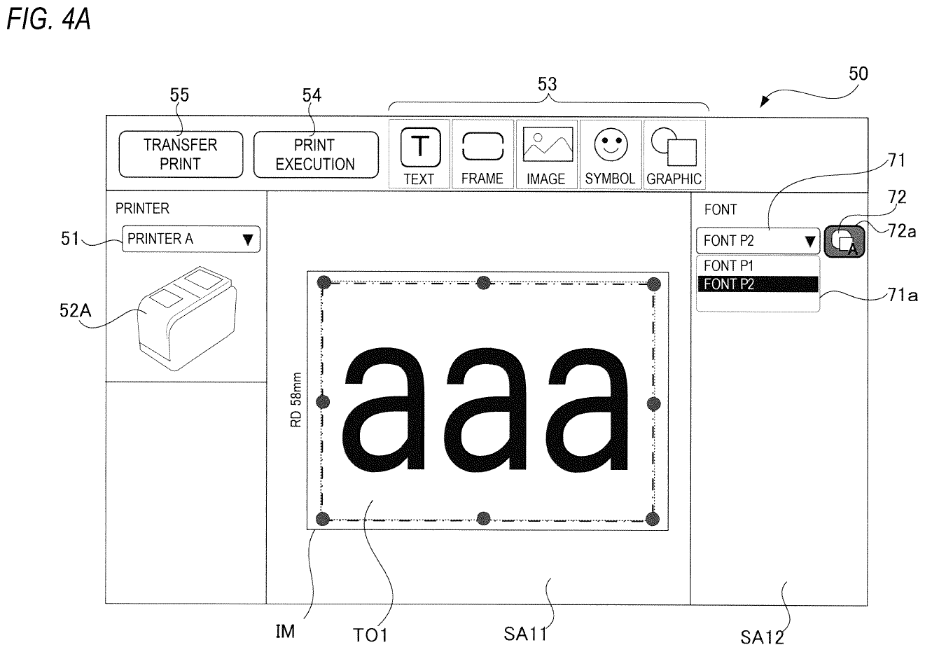

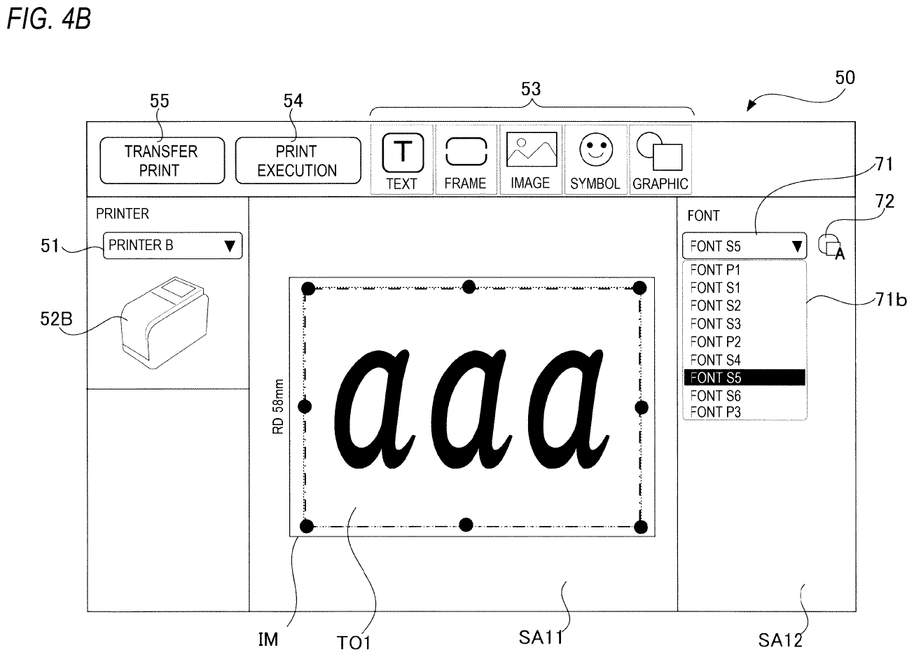

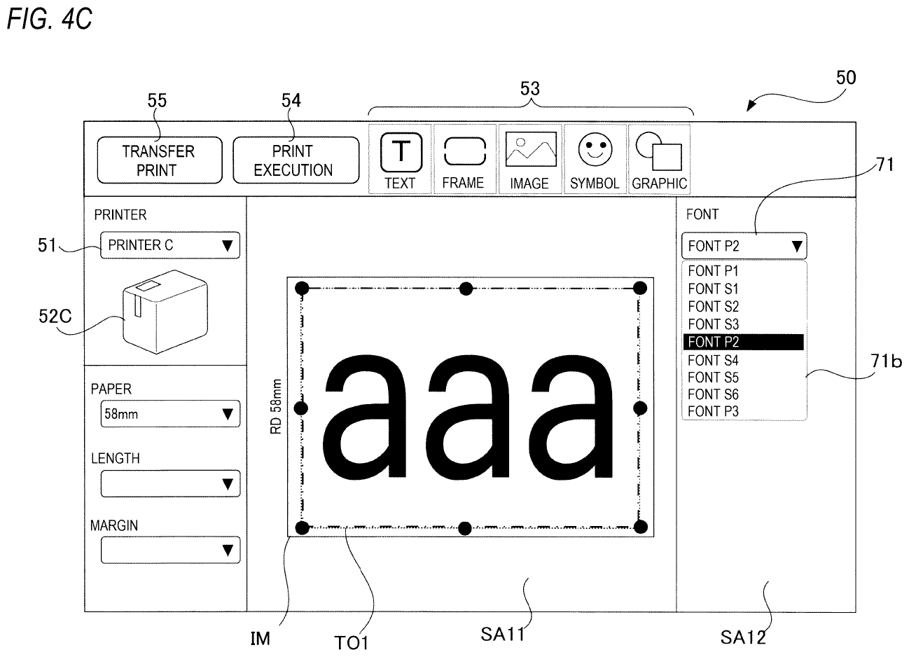

For example, the editing screen 50 illustrated in FIG. 4A includes a printer selection field 51, an editing image display region SA11, an editing setting region SA12, and various operation buttons.

The printer selection field 51 is an object for receiving selection of a printer to be controlled. The editing screen 50 displays an image of the printer according to the selection in the printer selection field 51. For example, an image 52A is displayed if the label printer 3A is selected, an image 52B is displayed if the label printer 3B is selected, and an image 52C is displayed if the label printer 3C is selected.

The editing setting region SA12 is a region for receiving editing of an object selected by an object selection button group 53. Examples of the object selected by the object selection button group 53 include a text object and a graphic object. In FIG. 4A, the text object is selected in the object selection button group 53, and an item for editing the text object is displayed in the editing setting region SA12. The item for editing the text object includes, for example, a font selection field 71 for receiving selection of a font. A toggle button 72 for switching a font group selectable in the font selection field 71 is displayed next to the font selection field 71. The font selection field 71 is an example of a “font selection object”. The toggle button 72 is an example of a “toggle button object”.

The editing screen 50 includes a print execution button 54 and a transfer print button 55. The print execution button 54 is an operator that receives a print instruction to execute a printing process described later. The transfer print button 55 is an operator that receives a transfer print instruction to execute the transfer printing process described later.

The toggle display control process will be described with reference to FIG. 3. The CPU 11 acquires model information of the label printer 3 selected in S12 or S13 of FIG. 2 (S31). The model information is information indicating the model of the label printer 3. The S31 is an example of an “acquisition process” and an “acquisition step”. The CPU 11 may acquire the model information when the label printer 3 is selected and store the model information in the memory 12, or may access the selected label printer 3 and acquire the model information when the S31 is executed. The CPU 11 also acquires information on the font that the selected label printer 3 has when acquiring the model information.

Based on the model information acquired in S31, the CPU 11 determines whether the selected label printer is a model compatible with transfer printing (S32). For example, when the label printer 3A or the label printer 3B is selected, the CPU 11 determines that the selected label printer is a transfer printing compatible model since the model information indicating the model compatible with the transfer printing function is acquired in S31. In the case of the transfer printing compatible model (S32: YES), the CPU 11 sets the toggle button 72 to be disposed on the editing screen 50 as illustrated in FIG. 4A (S33).

As illustrated in FIG. 3, the CPU 11 in which the toggle button 72 is disposed on the editing screen 50 determines whether the label printer is a model having a keyboard based on capability information of the selected label printer 3 (S41). The capability information may be acquired when the label creation application 41 is activated or when the PC 1 is activated, or may be acquired when the toggle display control process is executed. For example, the label printer 3A is a model having the keyboard 31A. When the label printer 3A is selected, the CPU 11 determines that the label printer 3A is a model having the keyboard based on the capability information of the label printer 3A (S41: YES). In the model having a keyboard, it is expected that text is edited on the label printer 3 side and more printing to be rendered on the label printer side is performed, and it is assumed that a printer-compatible font is used. Therefore, if the label printer is the model having a keyboard (S41: YES), the CPU 11 sets an initial state of the toggle button 72 to ON (S42), and ends the toggle display control process. For example, as illustrated in FIG. 4A, the CPU 11 indicating that the toggle button 72 is in the ON state by setting a display frame 72a surrounding the toggle button 72 to be disposed on the editing screen 50. The ON state of the toggle button 72 is a state in which a first font list 71a including only the printer-compatible fonts can be displayed. A group of options illustrated in the first font list 71a is an example of a “first group of options”.

For example, the label printer 3B is a model compatible with the transfer printing function, but is not a model having a keyboard. It is considered that the model that does not have a keyboard is not intended for editing text on the label printer 3B side. In such a model, even if the rendering function is provided, the frequency of use of transfer printing is low, and the transfer printing function is expected to be used for an exceptional purpose. If the label printer is the model that does not have a keyboard (S41: NO), the CPU 11 sets the initial state of the toggle button 72 disposed on the editing screen 50 to OFF (S43) although the model is compatible with the transfer printing function, and ends the toggle display control process. For example, as illustrated in FIG. 4B, the CPU 11 indicates that the toggle button 72 is in the OFF state by setting the display frame 72a not to be disposed on the editing screen 50. The OFF state of the toggle button 72 is a state in which a second font list 71b including the printer-compatible fonts and the printer-incompatible fonts can be displayed. A group of options illustrated in the second font list 71b is an example of a “second group of options”.

The label printer 3C is a model incompatible with the transfer printing function. When the label printer 3C is selected, the CPU 11 determines that the selected label printer 3C is not the transfer printing compatible model since the model information indicating the model compatible with the transfer printing function is not acquired. The model incompatible with the transfer printing function does not need to be limited to the printer-compatible font. Therefore, if the model is not the transfer printing compatible model (S32: NO), the CPU 11 sets the toggle button 72 not to be disposed on the editing screen 50 as illustrated in FIG. 4C (S36), and ends the toggle display control process. That is, the label creation application 41 is set not to accept a switching operation of the group of font options. When the toggle non-display is set, only the second font list 71b can be displayed in the font selection field 71.

Returning to FIG. 2, the CPU 11 displays the editing screen 50 (S15). The CPU 11 displays the toggle button 72 and the display frame 72a on the editing screen 50 according to the setting of the toggle display control process. That is, when the label printer 3 as a selection target is the transfer printing compatible model and the model having a keyboard, the toggle button 72 is displayed in the ON state, and when the label printer 3 as a selection target is the transfer printing compatible model but the model that does not have a keyboard, the toggle button 72 is displayed in the OFF state, and when the label printer 3 as a selection target is not the transfer printing compatible model, the toggle button 72 is hidden. S15 is an example of a “display process” and a “display step”.

The CPU 11 determines whether an editing operation related to the text is received on the editing screen 50 (S21). When it is determined that the editing operation related to the text is received (S21: YES), the CPU 11 executes the text editing process (S22), and the process proceeds to S23. Examples of the editing operation related to text include an operation of adding a text object, an operation of inputting text, a switching operation of the toggle button 72, and an operation of selecting a font. The text editing process is executed each time an editing operation related to text is received, and the text is edited according to the operation. The text editing process will be described later. When it is determined that the editing operation related to the text is not received (S21: NO), the CPU 11 skips S22 and the process proceeds to S23.

The CPU 11 proceeded to S23 determines whether another operation is received. For example, when an object other than the text object is selected in the object selection button group 53 of the editing screen 50 illustrated in FIG. 4A, when an operation of the print execution button 54 illustrated in FIG. 4A is received, or when an operation of the transfer print button 55 is received, the CPU 11 determines that another operation is received (S23: YES), executes a process corresponding to each operation (S24), and the process proceeds to S25. The process executed in response to the operation of the print execution button 54 and the process executed in response to the operation of the transfer print button 55 will be described later. When no other operation is received (S23: NO), the CPU 11 skips S24, and the process proceeds to S25.

In S25, the CPU 11 determines whether to end the editing of the label data (S25). The CPU 11 edits the label until an end instruction to end the editing of the label is received on the editing screen 50 (S25: NO). On the other hand, when the end instruction is received via the editing screen 50, the CPU 11 determines to end the editing (S25: YES), and ends the label editing process.

### Text Editing Process

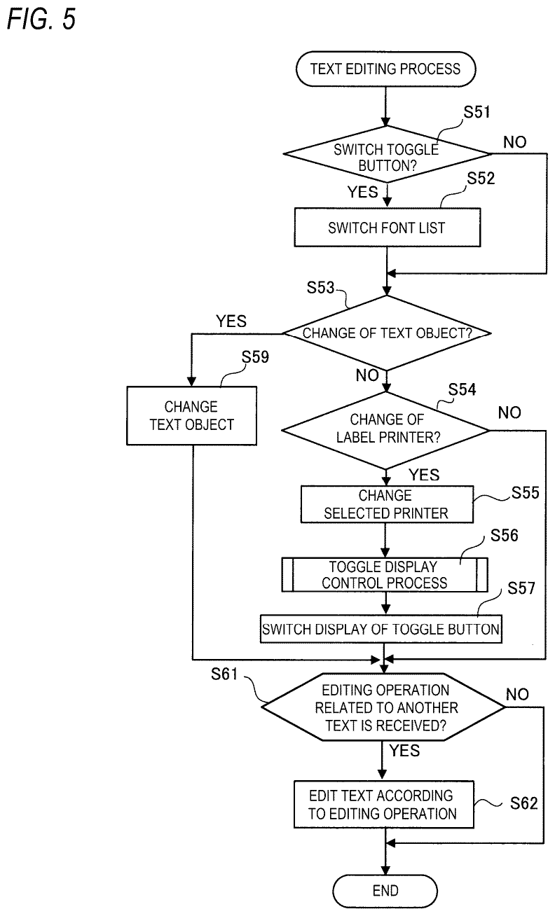

The above-described text editing process will be described with reference to FIG. 5. The CPU 11 determines whether the editing operation related to the text is the switching operation of switching the toggle button 72 (S51).

For example, as illustrated in FIG. 4A, when the label printer 3A is selected and the text object TO1 is selected, the CPU 11 initially displays the toggle button 72 in the ON state on the editing screen 50. When the toggle button 72 is in the ON state, the CPU 11 displays the first font list 71a on the editing screen 50 upon receiving an operation of a pull-down button of the font selection field 71. The first font list 71a includes, as the group of font options, only the printer-compatible fonts (fonts P1 and P2) that are the fonts that the label printer 3A has. Accordingly, the user can easily select one printer-compatible font (for example, “font P2”) that can be rendered by the label printer 3A.

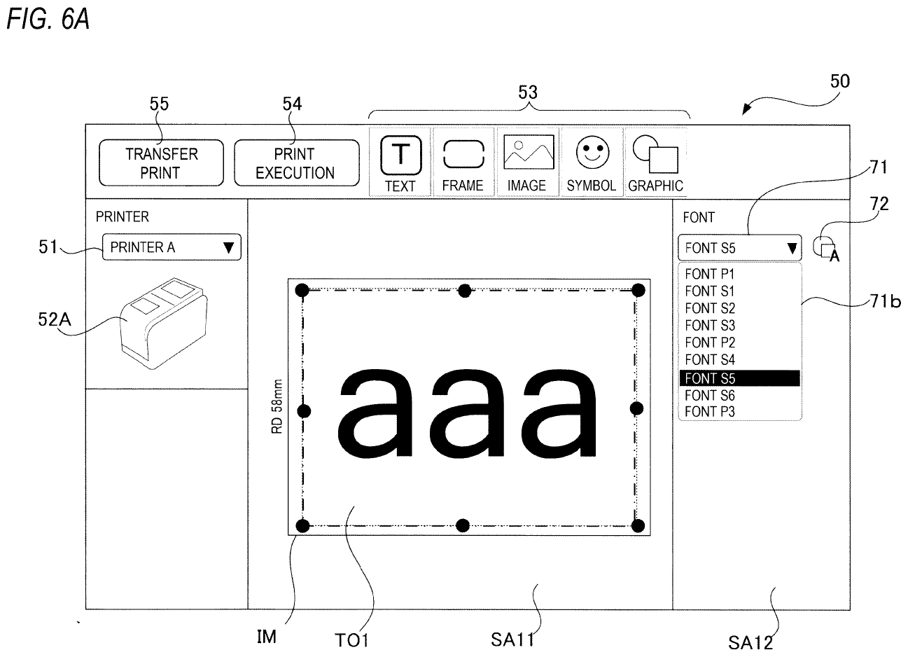

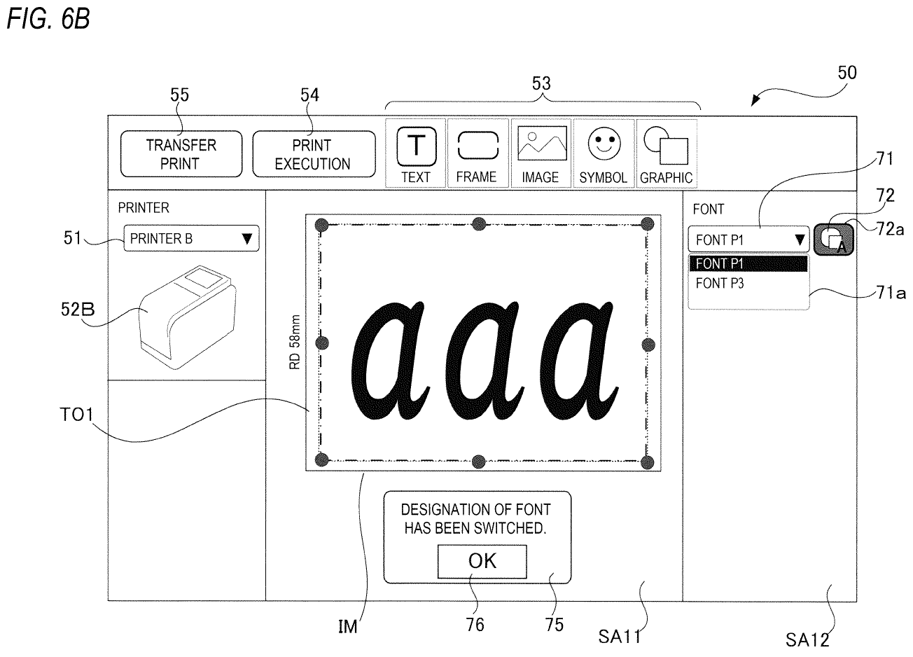

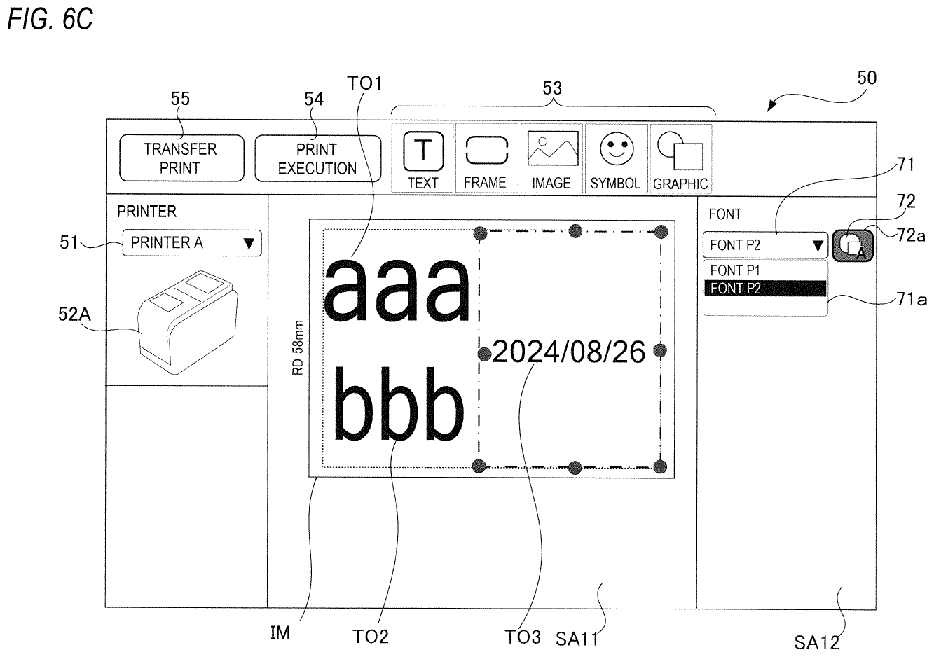

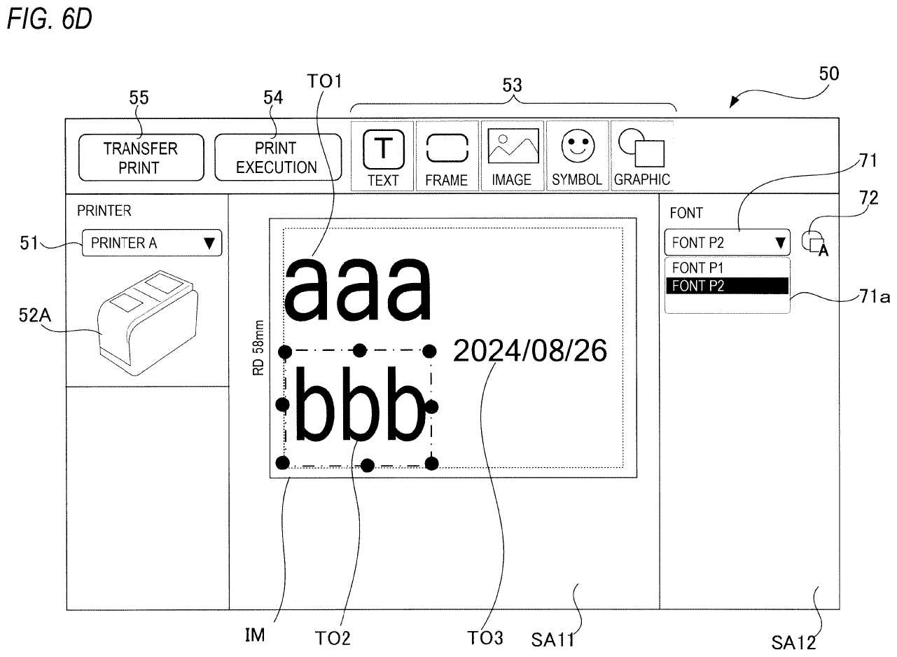

When the toggle button 72 in the ON state illustrated in FIG. 4A is switched to the OFF state as illustrated in FIG. 6A (S51: YES), the CPU 11 switches the first font list 71a to the second font list 71b (S52). The second font list 71b includes printer-compatible fonts (fonts P1 and P2) of the label printer 3A and printer-incompatible fonts (fonts S1 to S6 and P3), which are fonts that the label printer 3A does not have, that is, fonts stored in the font file 42, as the group of font options. Accordingly, when editing a label for which transfer printing is not to be performed, that is, a label that does not require editing with the label printer 3A, the user can select a printer-incompatible font (for example, “font S5”) from the second font list 71b by turning off the toggle button 72, and convenience is improved.

For example, as illustrated in FIG. 4B, when the label printer 3B is selected and a text object TO2 is selected, the CPU 11 initially displays the toggle button 72 in the OFF state on the editing screen 50. When the toggle button 72 is in the OFF state, upon receiving the operation of the pull-down button of the font selection field 71, the CPU 11 displays, on the editing screen 50, the second font list 71b including the printer-compatible fonts (fonts P1 and P3) that are the fonts that the label printer 3B has, and the printer-incompatible fonts (fonts S1 to S6 and P2) that are the fonts that the label printer 3B does not have, that is, the font list of the fonts held by the font file 42 of PC 1. Accordingly, even if the control target is the label printer 3B compatible with the transfer printing function, the printer-incompatible font can be included in selection targets of fonts, and it is possible to avoid a reduction in user convenience.

When the toggle button 72 in the OFF state illustrated in FIG. 4B is switched to the ON state as illustrated in FIG. 6B (S51: YES), the CPU 11 switches the second font list 71b to the first font list 71a including only the printer-compatible fonts (fonts P1 and P3) of the label printer 3B (S52). Accordingly, when the user selects the label printer 3B to perform the transfer printing, the user can easily select a font that can be rendered by the label printer 3B.

In this case, as illustrated in FIG. 4B, when the second font list 71b is switched to the first font list 71a by the switching operation of switching the toggle button 72 from the OFF state to the ON state in a state where one of the printer-incompatible fonts is designated, as illustrated in FIG. 6B, one of the fonts included in the first font list 71a (“font P1” in FIG. 6B) may be forcibly designated. At this time, a dialog 75 for notifying that the designation of the font has been switched may be displayed on the editing screen 50. When an OK button 76 of the dialog 75 is operated, the CPU 11 can receive another operation via the editing screen 50.

When one of the printer-incompatible fonts is designated and the second font list 71b is switched to the first font list 71a by the switching operation of the toggle button 72, the CPU 11 may set the font selection field 71 to a state in which no font is designated, that is, leave the font selection field 71 blank. Further, in the dialog 75, the user is asked whether to switch the designation of the font, and if the user selects not to switch the designation, the CPU 11 may cancel the switching operation of switching the toggle button 72 from the OFF state to the ON state.

As illustrated in FIG. 4C, when the toggle button 72 is not displayed on the editing screen 50, the switching operation of the toggle button 72 is not performed. In this case (S51: NO), the CPU 11 skips S52, and the process proceeds to S53.

As illustrated in FIG. 5, the CPU 11 that has proceeded to S53 determines whether the editing operation related to the text is a change of the text object (S53).

For example, when a text object TO2 or a text object TO3 is added to the label illustrated in FIG. 4A as illustrated in FIG. 6C, the CPU 11 determines that the text object is changed as illustrated in FIG. 5. When the text object TO2 is deleted, the CPU 11 determines that the text object is changed.

When the text object is changed (S53: YES), the CPU 11 changes the selected text object while maintaining the current selection of the label printer 3 (S59), and the process proceeds to S61. In this case, since the CPU 11 does not execute the toggle display control process of the S56, a display state of the toggle button 72 is maintained. For example, the toggle button 72 is displayed on the editing screen 50 in the ON state.

On the other hand, for example, when the selection of the text object TO1 is not changed on the editing screen 50 illustrated in FIG. 4A (S53: NO), the CPU 11 determines whether the editing operation related to the text is a change of the label printer 3 (S54).

For example, when the label printer 3 is changed in the printer selection field 51 of the editing screen 50 (S54: YES), the CPU 11 changes the selected printer. When the selected printer is changed (S55), the CPU 11 executes the toggle display control process of FIG. 3 (S56), and switches the display of the toggle button 72 according to the initial state of the label printer 3 after the change (S57). For example, when the control target is changed from the label printer 3A to the label printer 3B, the CPU 11 sets the toggle button 72 to the OFF state and displays the toggle button 72 on the editing screen 50 without the display frame 72a. For example, when the control target is changed from the label printer 3A to the label printer 3C, the CPU 11 does not display the toggle button 72 and the display frame 72a on the editing screen 50. Further, for example, when the control target is changed from the label printer 3B to the label printer 3A, the CPU 11 additionally displays the display frame 72a on the toggle button 72. Thereafter, the CPU 11 proceeds to S61.

When neither the text object nor the printer is changed (S54: NO, S55: NO), or when the change of the text object (S59) or the display change of the toggle button 72 (S57) is performed, the CPU 11 determines whether an editing operation related to another text is received (S61). When it is determined that the editing operation related to the other text is received (S61: YES), the CPU 11 edits the text according to the editing operation (S62), and ends the text editing process. For example, when it is determined that an operation of inputting text such as a character string or a date is received in a state where the text object is selected (S61: YES), the CPU 11 converts the input text into a font selected in the font selection field 71 and dispose the input text in the text object (S62). On the other hand, when it is determined that the editing operation related to the other text is not received (S61: NO), the CPU 11 skips S62 and ends the text editing process.

The CPU 11 can dispose the plurality of text objects TO1, TO2, and TO3 in a printable region of the label data, for example, as illustrated in FIG. 6C, by executing the text editing process according to the editing operation related to the text. The CPU 11 selects one (text object TO3 in FIG. 6C) of the plurality of text objects TO1, TO2, and TO3 (S53), and can receive the switching operation of the toggle button 72 in a state in which designation of a font (for example, “font P2”) is received (for example, in FIG. 6D, the toggle button 72 is switched from the ON state to the OFF state) (S51: YES, S52). Thereafter, even when the selection of the text object is switched to another text object (for example, the text object TO2 in FIG. 6D) (S53: YES), the CPU 11 maintains the selection of the label printer 3A (S54) and continues to display the first font list 71a.

In this way, the label creation application 41 displays the font list for each label, not for each of the plurality of text objects TO1, TO2, and TO3. Therefore, the label creation application 41 can avoid mixing the printer-compatible font and the printer-incompatible font in one piece of label data, and can select a font suitable for the selected label printer 3A.

### Printing Process

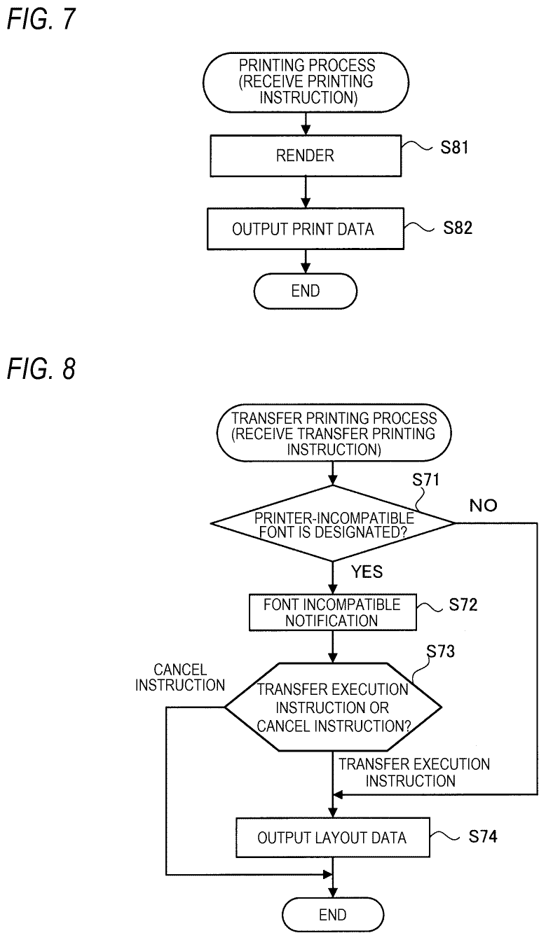

The above-described printing process will be described with reference to FIG. 7. When the operation of the print execution button 54 is received on the editing screen 50, the CPU 11 renders the label data edited on the editing screen 50 to generate the print data (S81), and outputs the print data to the label printer 3 selected in the printer selection field 51 (S82). The label printer 3 that has received the print data executes printing based on the print data and creates a label.

In the printing process, since the label edited by using the label creation application 41 is rendered by the label creation application 41 and is not rendered by the label printer 3, even when the edited label includes the label printer 3 that is incompatible with the printer, the label printer 3 can appropriately print the label.

### Transfer Printing Process

The above-described transfer printing process will be described with reference to FIG. 8. When the operation of the transfer print button 55 is received on the editing screen 50, the CPU 11 executes the transfer printing processing illustrated in FIG. 8 using the label creation application 41.

The CPU 11 determines whether the edited label data includes a text object for which a printer-incompatible font is designated (S71). When the edited label data does not include the text object for which the printer-incompatible font is designated (S71: NO), the CPU 11 outputs layout data thereof to the selected label printer 3 in S74 (S74), and ends the transfer printing process.

When the control target is the label printer 3A, the label printer 3A waits for input of a print instruction by the keyboard 31A. The label printer 3A displays the received layout data on a display unit of the self label printer 3A, and can receive an operation of adding or deleting a text object to or from the layout data and an operation of changing text set in the text object included in the layout data using the keyboard 31A. When receiving a print execution instruction via an operation unit such as the keyboard 31A, the label printer 3A renders the changed layout data and prints the rendered image. Therefore, since the user can edit and print the text of the layout data by the label printer 3A at the site where the label printer 3A is installed, it is possible to perform printing with a high degree of freedom. Note that the label printer 3A may automatically execute printing without requiring input of the print execution instruction.

For example, when the control target is the label printer 3B, the label printer 3B that has received the layout data renders the received layout data and prints the rendered image. The label printer 3B may execute printing in response to an operation of a print execution button provided on a main body or an operation from the PC.

When the label printer 3C is selected as the selection target on the editing screen 50, the CPU 11 does not display the transfer print button 55 on the editing screen 50 as illustrated in FIG. 4C. That is, in a state in which the label printer 3C is selected, the transfer printing process is not executed. Therefore, even if a printer-incompatible font is designated by a label in the state in which the label printer 3C is selected, the label creation application 41 renders the label by the PC 1 using the font that the PC 1 has and outputs the label to the label printer 3C, so that the label printer 3C can perform appropriate printing.

As illustrated in FIG. 8, when the edited label data includes the text object for which the printer-incompatible font is designated (S71: YES), the CPU 11 performs a font incompatible notification using the user IF 13 (S72), and the process proceeds to S73. S72 is an example of a “guidance process”, a “warning process”, and a “guidance step”.

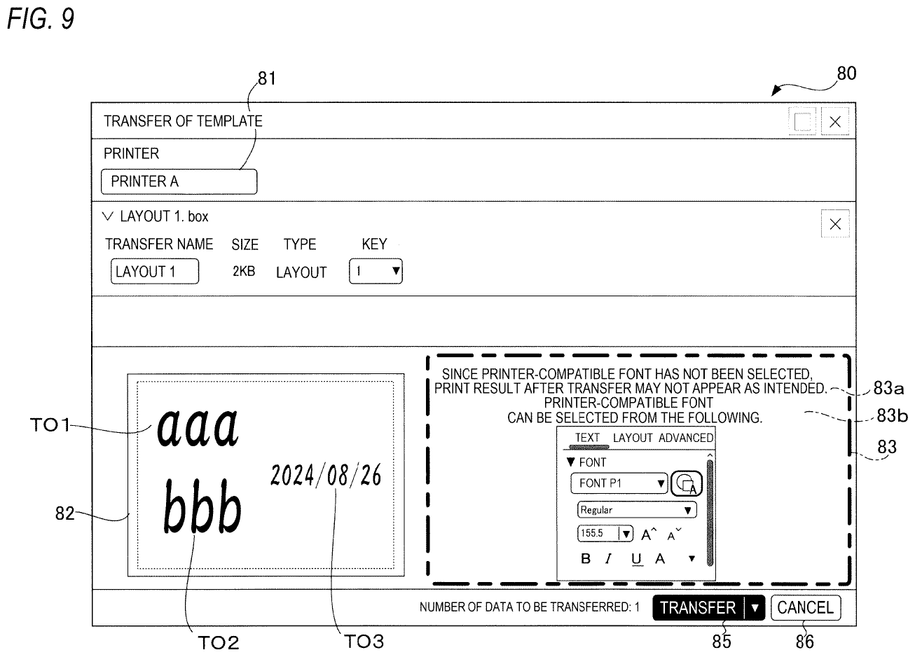

FIG. 9 shows an example of the font incompatible notification. For example, a transfer print screen 80 illustrated in FIG. 9 displays a printer display field 81 for displaying the selected printer and a preview screen 82 for label data to be printed. In the present embodiment, in a state in which the label printer 3A is selected, the font “font S5”, which is a printer-incompatible font, is set for the text objects TO1, TO2, and TO3. Since the printer-incompatible font is set in the label data, the CPU 11 displays a font incompatible notification 83 on the transfer print screen 80. The font incompatible notification 83 includes a warning 83a that the designated printer-incompatible font is not appropriately printed. The font incompatible notification 83 includes a guide 83b for switching the font list in the font selection field 71 to the first font list 71a by the switching operation of the toggle button 72. The transfer print screen 80 includes a transfer button 85 and a cancel button 86.

As illustrated in FIG. 8, when the CPU 11 receives a transfer execution instruction in response to the operation of the transfer button 85 (S73: transfer execution instruction), the CPU 11 outputs the layout data including the text object for which the printer-incompatible font is designated to the selected label printer 3A using the communication IF 14 (S74), and ends the transfer printing process. The layout data is data on which rendering has not been performed. The S74 is an example of an “output process” and an “output step”.

Upon receiving the layout data including the printer-incompatible font, the label printer 3A converts the printer-incompatible font into one of the font-compatible fonts that the label printer 3A has (for example, “font P1”) at rendering, performs rendering, and performs printing. Therefore, the print result may be against the user's intention.

On the other hand, when the CPU 11 receives a cancel instruction in response to the operation of the cancel button 86 (S73: transfer execution instruction), the CPU 11 ends the transfer printing process without outputting the layout data to the selected label printer 3A. For example, the user can check the warning 83a, know that the label cannot be printed according to his or her intention, and operate the cancel button 86 to avoid unintended printing.

The warning 83a may include information indicating that a text object for which a printer-incompatible font is designated. Accordingly, for example, even in a case where the designation of the font is different for each text object, the user can easily recognize the text object for which the printer-incompatible font is designated.

The user can switch the toggle button 72 from the OFF state to the ON state based on the guidance 83b. The first font list 71a is displayed in the font selection field 71 in which the toggle button 72 is switched to the ON state. For example, the user changes the font “font S5” designated in the text objects TO1, TO2, and TO3 to the printer-compatible font “font P2”, and performs transfer printing again. The label printer 3A renders the layout data and performs printing. Accordingly, it can be expected that the label printer 3A renders the layout data including only the text object for which the printer-compatible font is designated, and executes printing as intended by the user.

### SUMMARY

As described above, the label creation application 41 according to the present embodiment receives, by the switching operation, whether the font options selectable on the editing screen 50 are the first font list 71a including only the printer-compatible fonts as the group of options or the second font list 71b including the printer-compatible fonts and the printer-incompatible fonts as the group of options. The user who wants to use only the printer-compatible font can avoid selecting the printer-incompatible font by setting the font options selectable on the editing screen 50 to the first font list 71a. On the other hand, since the font options selectable on the editing screen 50 can be set to the second font list 71b, the user who is not concerned only with the printer-compatible font can select a font including the printer-incompatible font by switching to the second font list 71b, and the user convenience at the time of font selection is not impaired.

When the label printer 3C incompatible with the transfer printing function is the control target, there is no need to limit the group of font options to the printer-compatible fonts. In this case, the label creation application 41 hides the toggle button 72. Accordingly, it is possible to prevent the user who does not need to limit the fonts to the printer-compatible fonts from unintentionally performing the switching operation of the toggle button 72 and limiting the font options to the printer-compatible fonts.

The program having the above configuration receives, by a switching operation, whether to set the font option selectable on the editing screen as the first group of options including only the printer-compatible font or the second group of options also including the printer-incompatible font. The user who wants to use only the printer-compatible font can avoid selecting the printer-incompatible font by setting the font option selectable on the editing screen as the first group of options. On the other hand, since the font option selectable on the editing screen can also be set as the second group of options, a user who is not concerned only with the printer-compatible font can select a font including the printer-incompatible font by switching to the second group of options, and user convenience at the time of font selection is not impaired.

A method and an apparatus for implementing functions of the program, and a computer-readable storage medium storing the program are also novel and useful.

According to the technique disclosed in the present specification, a technique for easily selecting an appropriate font in an information processing apparatus connected to a label printer is implemented.

The embodiment disclosed in the present specification is merely an example, and does not limit the present invention. Therefore, various improvements and modifications can be naturally made to the technique disclosed in the present specification without departing from the gist of the present invention.

The font incompatible notification illustrated in S72 of FIG. 8 may cause the user IF 13 to display either the warning 83a or the guidance 83b. The warning 83a and the guidance 83b may be displayed on different screens.

For example, the font incompatible notification illustrated in S72 of FIG. 8 may be omitted. However, by displaying the guide 83b on the user IF 13, the label creation application 41 can expect the use of the switching operation from the subsequent editing. Further, by displaying the warning 83a on the user IF 13, the label creation application 41 can avoid printing unintended by the user.

For example, S41 to S43 in FIG. 3 may be omitted. However, even if the model is compatible with transfer printing, there is a model for which it is assumed that there is no need to limit the fonts to the printer-compatible fonts. For example, since the label printer 3B that does not include a keyboard does not include a keyboard and does not assume editing of layout data, more printing that is not edited on the printer side is performed, and the necessity of limiting the fonts to the printer-compatible fonts is low. Therefore, even in the label printer 3B which is a model compatible with the transfer printing and in which the switching operation of the toggle button 72 can be performed, the label creation application 41 can control whether the initial state of the options of the font selection object is set to the first font list 71a or the second font list 71b, and thus can provide the editing screen 50 more suitable for actual operation.

For example, S56 in FIG. 5 may be omitted, and the display state of the toggle button 72 may not be automatically switched based on the initial state of the printer after the change. However, when the label printer 3 to be controlled is changed, the label creation application 41 can provide an editing screen suitable for the current control target by determining whether the switching operation of the toggle button 72 is possible and an initial value of the option of the font selection object according to the model of the label printer 3 after the change.

For example, S54 in FIG. 5 may be omitted, and the first font list 71a and the second font list 71b may be switched according to the change of the text object. However, the label creation application 41 can avoid an inappropriate font from being selected by switching options selectable on the font selection object not for each text object but for each label.

For example, the switching operation of switching between the first font list 71a and the second font list 71b is not limited to the operation of the toggle button 72, but may be an operation of an icon or an operation of an option in a menu.

In any flowchart disclosed in the embodiment, an execution order of a plurality of processes in any of a plurality of steps can be freely changed or can be executed in parallel within a range in which no contradiction occurs in a processing content.

The processes disclosed in the embodiment may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a program executable by one or more processors of an information processing apparatus connected to a label printer and having a label editing function, the program causing the information processing apparatus to execute:
a display process of displaying, on a user interface of the information processing apparatus, an editing screen that receives editing of a label and on which a font selection object for receiving selection of a font is disposed, wherein
the program further causes the information processing apparatus to receive a switching operation of switching an option selectable on the font selection object between a first group of options and a second group of options, the first group of options includes only a printer-compatible font that is a font that the label printer has, the second group of options includes the printer-compatible font and a printer-incompatible font that is a font that the label printer does not have.

2. The storage medium according to claim 1, the program further causing the information processing apparatus to execute:
an acquisition process of acquiring model information indicating a model of the label printer, wherein
in a case where the model indicated by the model information acquired in the acquisition process is a specific model, the editing screen on which the switching operation is able to be performed is displayed on the user interface of the information processing apparatus, and
in a case where the model indicated by the model information acquired in the acquisition process is not the specific model, the editing screen on which the switching operation is unable to be performed and the option selectable on the font selection object is set as the second group of options is displayed on the user interface of the information processing apparatus.

3. The storage medium according to claim 2, the program further causing the information processing apparatus to execute:
an output process of outputting layout data indicating a layout of a label edited on the editing screen, wherein
the layout data is data that is not rendered, the label printer includes a model compatible with a specific printing function and a model incompatible with the specific printing function, the specific printing function is a function of rendering the layout data output in the output process and performing printing based on a print image generated by the rendering, and
the program further causes the information processing apparatus to set the model compatible with the specific printing function as the specific model.

4. The storage medium according to claim 3, the program further causing the information processing apparatus to execute:
a guidance process of displaying, on the user interface of the information processing apparatus, a guidance indicating that the option on the font selection object is switched to the first group of options by the switching operation, in a case where an instruction of outputting the layout data including a text object for which the printer-incompatible font is specified is given.

5. The storage medium according to claim 3, the program further causing the information processing apparatus to execute:
a warning process of displaying, on the user interface of the information processing apparatus, a warning that the specified printer-incompatible font is not to be printed, in a case where an instruction of outputting the layout data including a text object for which the printer-incompatible font is specified is given.

6. The storage medium according to claim 2, wherein
the specific model includes a first specific model and a second specific model,
the program further causes the information processing apparatus to
display, on the user interface of the information processing apparatus, the editing screen on which the switching operation is able to be performed and an initial state of the option selectable on the font selection object is set as the first group of options in a case where the model indicated by the model information acquired in the acquisition process is the first specific model, and
display, on the user interface of the information processing apparatus, the editing screen on which the switching operation is able to be performed and an initial state of the option selectable on the font selection object is set as the second group of options in a case where the model indicated by the model information acquired in the acquisition process is the second specific model.

7. The storage medium according to claim 6, the program further causing the information processing apparatus to execute:
an output process of outputting layout data indicating a layout of a label edited on the editing screen, wherein
the layout data is data that is not rendered, the label printer includes a model compatible with a specific printing function and a model incompatible with the specific printing function, the specific printing function is a function of rendering the layout data output in the output process and performing printing based on a print image generated by the rendering, and
the information processing apparatus is further caused to set the model compatible with the specific printing function and having a keyboard for receiving text input as the first specific model, and set the model compatible with the specific printing function and having no keyboard as the second specific model.

8. The storage medium according to claim 6, wherein
the program further causes the information processing apparatus to
receive a change operation for changing a label printer to be controlled, and
the information processing apparatus is further caused to
determine whether the switching operation is able to be performed according to the model of the changed label printer when the label printer to be controlled is changed by the change operation, and determine whether the initial state of the option selectable on the font selection object is set as the first group of options or the second group of options when the switching operation is able to be performed.

9. The storage medium according to claim 1, wherein
the program further causes the information processing apparatus to
dispose a plurality of text objects on a label via the editing screen, receive a font designation by the font selection object for each of the text objects, and not switch the option selectable on the font selection object even if a selection target is switched to another one of the plurality of text objects after the switching operation is performed with one of the plurality of text objects selected.

10. The storage medium according to claim 1, wherein
the program further causes the information processing apparatus to
display, on the user interface of the information processing apparatus, the editing screen on which a toggle button object for receiving the switching operation is disposed.

11. A control method of an information processing apparatus connected to a label printer, the method comprising:
a display step of displaying, on a user interface of the information processing apparatus, an editing screen that receives editing of a label and on which a font selection object for receiving selection of a font is disposed, wherein
in the display step, a switching operation of switching an option selectable on the font selection object between a first group of options and a second group of options is receivable, the first group of options includes only a printer-compatible font that is a font that the label printer has, the second group of options includes the printer-compatible font and a printer-incompatible font that is a font that the label printer does not have.

12. The control method according to claim 11 further comprising:
an acquisition step of acquiring model information indicating a model of the label printer, wherein
in the display step,
in a case where the model indicated by the model information acquired in the acquisition step is a specific model, the editing screen on which the switching operation is able to be performed is displayed on the user interface of the information processing apparatus, and
in a case where the model indicated by the model information acquired in the acquisition step is not the specific model, the editing screen on which the switching operation is unable to be performed and the option selectable on the font selection object is set as the second group of options is displayed on the user interface of the information processing apparatus.

13. The control method according to claim 12 further comprising:
an output step of outputting layout data indicating a layout of a label edited on the editing screen, wherein
the layout data is data that is not rendered, the label printer includes a model compatible with a specific printing function and a model incompatible with the specific printing function, the specific printing function is a function of rendering the layout data output in the output step and performing printing based on a print image generated by the rendering, and
in the display step,
the model compatible with the specific printing function is set as the specific model.

14. The control method according to claim 13 further comprising:
a guidance step of displaying, on the user interface of the information processing apparatus, a guidance indicating that the options of the font selection object are switched to the first group of options by the switching operation, in a case where an instruction of outputting the layout data including a text object for which the printer-incompatible font is specified is given.
